(19) United States
(12) Patent Application Publication
(10) Pub. No.: US 2015/0151598 A1
(43) Pub. Date: Jun. 4, 2015

(54) Wheel Suspension

(71) Applicant: Daimler AG, Stuttgart (DE)

(72) Inventors: Hubert Bruehl, Waldstetten (DE); Rainer Hack, Brackenheim (DE); Klaus Russ, Gingen (DE)

(21) Appl. No.: 14/406,778

(22) PCT Filed: May 8, 2013
(86) PCT No.: PCT/EP2013/001370

§ 371 Date: Dec. 10, 2014

(30) Foreign Application Priority Data
Jun. 14, 2012 (DE) 10 2012 011 868.6

(51) Int. Cl. B60G 3/26; B60G 7/00; B60G 3/20

(52) U.S. Cl. CPC B60G 3/26; B60G 3/20; B60G 7/005

(57) ABSTRACT

A motor vehicle wheel suspension is configured so that the wheel suspension is stiff for transverse forces and elastic for longitudinal forces by running an inner connection line connecting the rear guide bearing to the front guide bearing, in a projection having a vertical projection direction and a horizontal projection plane, substantially in parallel to an outer connection line connecting the lower coupler bearing to the lower ball joint.

### CROSS-REFERENCE TO RELATED APPLICATIONS

The present application is related to PCT International Application PCT/EP2013/001371, filed May 8, 2013, a national stage application of which is assigned U.S. application No. ______.

### BACKGROUND AND SUMMARY OF THE INVENTION

Exemplary embodiments of the present invention relate to a wheel suspension for a motor vehicle for the support of a wheel of the vehicle on the structure of the vehicle, as well as a motor vehicle equipped with at least one such wheel suspension.

European patent document EP 1 870 263 B1 discloses a wheel suspension having a wheel carrier for the coupling to a vehicle wheel as well as a lower trapezoidal link which has, on the inside, a rear guide bearing for the coupling to a vehicle structure and a front guide bearing for the coupling with the vehicle structure and which is coupled to the wheel carrier on the outside via a lower ball joint. Furthermore, the wheel suspension comprises an upper camber link which has, on the inside, an upper guide bearing for coupling to the vehicle structure and which is coupled to the wheel carrier on the outside via an upper ball joint. Furthermore, the known wheel suspension is equipped with a coupler link coupled to the trapezoidal link via a lower coupler bearing and to the wheel carrier via an upper coupler bearing. The known wheel suspension is provided for an unsteered rear wheel. Nevertheless, it is equipped with a tie rod that is coupled on the outside to the wheel carrier via a footstep bearing and is connected on the inside to an actuator, with the help of which a toe angle as well as a camber angle are able to be changed depending on the operational state of a vehicle equipped with the wheel suspension. Finally, the known wheel suspension is furthermore equipped with a damper, which is supported with a lower damper support on the upper camber link, and a spring, which is supported via a lower spring support on the trapezoidal link in the region of a connection line, which connects the front guide bearing to the lower ball joint.

Exemplary embodiments of the present invention are directed to improving a wheel suspension of the type described above or for a related vehicle, which is distinguished in particular by an improved suspension and directional stability. Furthermore, exemplary embodiments are directed to achieving a wheel control that is comparatively stiff and precise in the vehicle transverse direction, while being comparatively elastic or flexible in the vehicle longitudinal direction. Furthermore, exemplary embodiments provide high-quality noise damping.

The present invention is based on the general idea to position, in the case of such a wheel suspension, the rear guide bearing, the front guide bearing, the lower coupler bearing and the lower ball joint such that in a projection characterized by a vertical projection direction and a horizontal projection plane, an inner connection line that connects the rear guide bearing to the front guide bearing runs substantially in parallel to an outer connection line which connects the lower ball joint to the lower coupler bearing. The formulation “substantially” therein does not exclude an angle between the inner connection lines and the outer connection lines in the projection plane, wherein this angle, however, is not greater than 20°, is preferably not greater than 15°, is preferably not greater than 10°, is preferably not greater than 5°. Due to the parallel direction of these connection lines, the guiding of the wheel carrier can be improved during compression and decompression, which affects the angled suspension advantageously and also improves the directional stability of the related wheel during compression and decompression.

The wheel suspension presented here can be designed particularly simply as a wheel suspension for a steerable vehicle wheel. In particular, the wheel suspension can be provided for a rear wheel. Furthermore, the wheel suspension can be an independent wheel suspension.

Advantageously, the inner connection line extends, in particular in the case of a wheel suspension conceived as a rear wheel suspension, frontwards, upwards, and outwards from the rear guide bearing to the front guide bearing. This is achieved, in an assembled state on the structure by a corresponding spatial arrangement of the rear guide bearing and of the front guide bearing. This spatial alignment of the inner connection lines defines a longitudinal pole for the respective vehicle wheel, around which the respective wheel is mounted to be able to swivel by means of the wheel suspension, and leads to an improved start-up support. In the ideal case, the longitudinal pole lies in the direction of a resulting reaction force arising during start-up and engaging with the respective wheel such that this reaction force is orientated substantially by the longitudinal pole and thus substantially cannot generate torque on the wheel such that the wheel substantially does not decompress during start up. A corresponding behavior is set in a driven wheel, also in a propulsion operation as well as in a load change, such that also a propulsion support as well as a load change support can be considerably improved. Lastly, it is particularly interesting in the case that a recuperation operation is implemented via the driven wheel, preferably in connection to the electromotor, which can lead to comparatively strong load changes on the wheel. The improved support increases the driving comfort and stabilizes the driving behavior of the vehicle.

In the case of another advantageous embodiment, the rear guide bearing is situated behind a wheel pivot, while the front guide bearing is situated in front of the wheel pivot. Optionally, it can furthermore be provided that, in a projection characterized by a vertical projection direction and a horizontal projection plane, a rear connection line that connects the rear guide bearing to the lower ball joint is at an acute angle with the wheel pivot. Due to these measures, a transverse support of the vehicle wheel with regard to a pneumatic trail can be improved in such a way that the transverse support occurs extensively via the rear guide bearing, while the front guide bearing is unburdened extensively from these transverse forces. In the ideal case, a distance of the rear guide bearing from the wheel pivot is coordinated with the usual pneumatic trail. This embodiment of the wheel suspension leads, in particular, to a significant unburdening of the front guide bearing such that this can be conceived to be weaker, whereby the wheel suspension overall has a weaker or more elastic effect for the longitudinal forces.

According to a particularly advantageous embodiment, a front connection line, which connects the front guide bearing to the lower ball joint, can run substantially perpendicularly to the inner connection lines in the projection named above. Due to this measure, a direct force support can be implemented on the front guide bearing. Furthermore, a compact construction is supported by this geometry. Also, the formulation “substantially” does not exclude deviations from a right angle between the front connection lines and the inner connection lines in said horizontal projection plane. These deviations are, however, smaller than 20°, preferably smaller than 15°, preferably smaller than 10°, preferably smaller than 5°.

In other advantageous embodiments, the lower ball joint, the upper coupler bearing and the lower ball joint can define a steering axle for steering movements between wheel and structure. In one such configuration, the coupler link is continuously unburdened during statically stable driving states.

According to an advantageous embodiment, the wheel suspension can be equipped with a tie rod coupled to the wheel carrier on the outside via a footstep bearing, wherein the upper coupler bearing is arranged between the upper ball joint and the footstep bearing is arranged on the wheel carrier. The selected positioning leads to a comparably long coupler link that enables a stable support between wheel carrier and trapezoidal link. Thus, the stiffening of the wheel suspension can be improved with regard to transverse forces.

According to another advantageous embodiment, a wheel bearing can be provided, with the help of which the respective vehicle wheel can be fixed to the wheel suspension. This wheel bearing is herein fixed to the wheel carrier. Furthermore, according to an advantageous development, a drive shaft can be provided to drive a wheel hub of the wheel bearing. Thus, the wheel suspension presented here can be used for a driven wheel. The drive shaft can therein be connected in a usual manner to a drive train of the vehicle. Likewise, it is possible to couple the drive shaft to an electromotor allocated to the respective vehicle wheel.

Provided that the driven wheel is furthermore a steerable wheel, the drive shaft can expediently have a drive joint. Particularly advantageous now is an embodiment in which the drive joint lies in the region of the steering axle. Due to this measure, forces can be reduced that can occur during steering and/or during compressing and decompressing of the wheel carrier in the drive joint. Furthermore, due to this measure, slide paths can be reduced that occur on a further, inner bearing during steering, via which the respective drive shaft is connected to be driven to the drive train or to the respective electro motor.

In another advantageous embodiment, the camber link can lie in the region of a horizontal wheel central plane in which a wheel pivot lies. Hereby the lever available for the transfer of steering forces is particularly large, whereby the forces to be applied via the tie rod can be reduced accordingly and in particular the tie rod can be dimensioned to be lighter.

According to another advantageous embodiment, a damper can be supported via a lower damper support on the trapeze bearing and which is able to be supported via an upper damper support or on the structure. The lower damper support is preferably arranged in the region of a lower connection line which connects the lower guide bearing to the lower ball joint. In this way, damping forces have an effect substantially only in the region of this lower connection line, whereby toques are avoided or reduced on the lower guide bearing. In this way, in particular the front guide bearing can be conceived as an elastomer bearing designed to be particularly weak.

According to another advantageous embodiment, a spring can be supported via a lower spring support on the trapezoidal link and which can be supported via an upper support or on the vehicle structure. Expediently, the lower spring support can now lie in the region of a lower connection line which connects the lower guide bearing to the lower ball joint. Thus, spring forces have an effect fundamentally only on this lower connection line, which means an unburdening of the front guide bearing, whereby this for example, can be conceived to be particularly weak.

A combination of both embodiments named above is particularly advantageous such that both the damper and the spring lie in the region of the rear connection line over their respective lower support. Therein, damper and spring can be arranged separately and eccentrically to each other such that the lower damper support and the lower spring support are not arranged coaxially but next to each other and at a distance to each other. As far as the damper and spring are implemented separately, it can be preferred to arrange the lower spring support further inside, so proximally to the lower guide bearing, while the lower damper support is then arranged expediently proximally to the lower ball joint. Alternatively, a coaxial arrangement of damper and spring is fundamentally conceivable, for example in the form of a combined damper and spring strut.

According to another advantageous embodiment, the wheel suspension can be equipped with a stabilizer, which is coupled to the coupler link via a pendulum strut. Due to this measure, on the one hand a direct coupling is prevented between stabilizer and wheel carrier, whereby the freedom of design for the wheel carrier is considerably improved, which in particular considerably simplifies the design of the wheel suspension for a steerable wheel. On the other hand, the coupler link is coupled directly to the wheel carrier with regard to its movements such that an operative connection between the wheel carrier and the stabilizer that responds well or directly is also able to be achieved via the pendulum strut. In particular, the stabilizer can hereby be hinged within the wheel suspension comparably far on the outside, whereby the stabilizer works sensitively and can be designed overall to be lighter.

According to another advantageous embodiment, the wheel suspension can be designed having a steering stop with a first stop contour and a second stop contour, which abut onto each other on reaching the predetermined maximum steering angle between wheel and structure, wherein the first stop contour is formed on the wheel carrier while the second stop contour is formed on the coupler link. As the coupler link is adjusted analogically to the wheel carrier by its direct coupling with the wheel carrier, hardly any relative movements occur during steering and/or during compression or decompression between wheel carrier and coupler link, whereby the wear can be considerably reduced in the steering stop. Furthermore the geometries of the stop contours can be designed considerably more simply as the coupler link and the wheel carrier are hardly moved relative to each other during compression and decompression.

According to another advantageous embodiment, a wheel contact point and wheel pivot lie on the steering axle in a projection with a horizontal projection direction and a vertical projection plane. Hereby additional forces can be reduced in the wheel suspension during steering of the wheel.

The vehicle according to the invention is characterized by a structure, by several wheels and by at least one wheel suspension of the type described above, with the help of which one of the wheels is supported on the structure.

Further important features and advantages of the invention arise from the drawings and the corresponding description of the figures by means of the drawings.

It is understood that the features that are named above and are still to be illustrated below are not only able to be used in the respectively specified combination, but also in other combinations or individually, without exceeding the scope of the present invention.

Preferred exemplary embodiments of the invention are depicted in the drawings and illustrated in greater detail in the description below, wherein the same reference numerals refer to the same or similar or functionally identical components.

In the general description above and in the description of the figures below, the used relative terms “lower”, “upper”, “rear”, “front”, “inner” and “outer” are to be understood in the view of the installed state of the wheel suspension on the vehicle. Thus “lower” is facing a subsurface on which the wheel of the vehicle stands. Accordingly “upper” is facing away from the subsurface. The term “rear” means in the direction of the vehicle rear. The term “front” means in the direction of the vehicle front. The term “inner” points transversely to the vehicle longitudinal direction to the center of the vehicle. The term “outer” points transversely to the vehicle longitudinal direction away from the vehicle center. BRIEF DESCRIPTION OF THE DRAWING FIGURES

Herein are shown, schematically respectively,

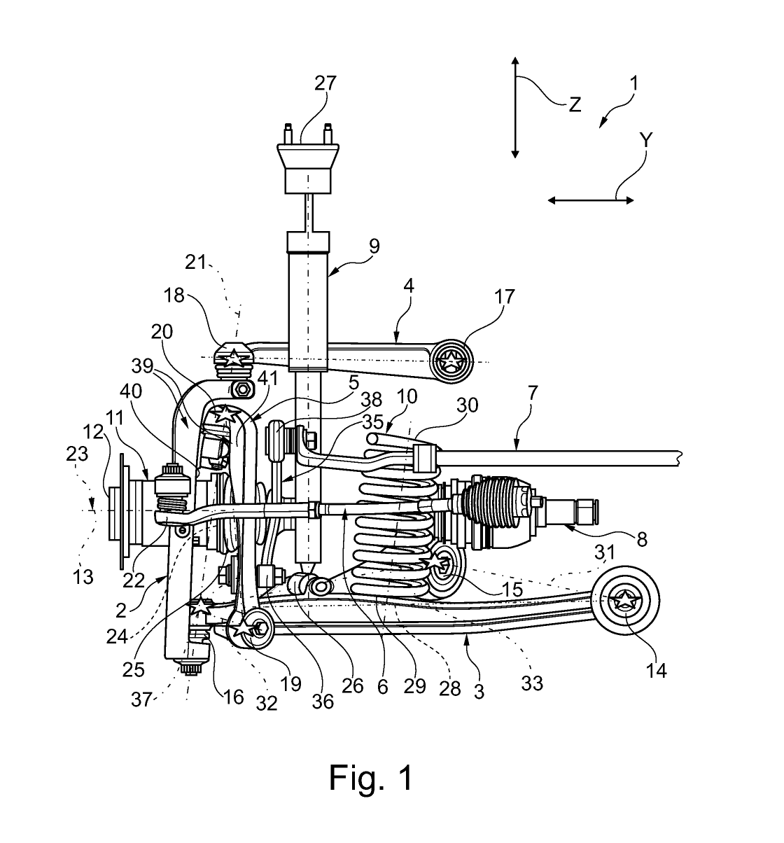

FIG. 1 a view of a wheel suspension from behind in a longitudinal direction (X axis) of a thus equipped vehicle,

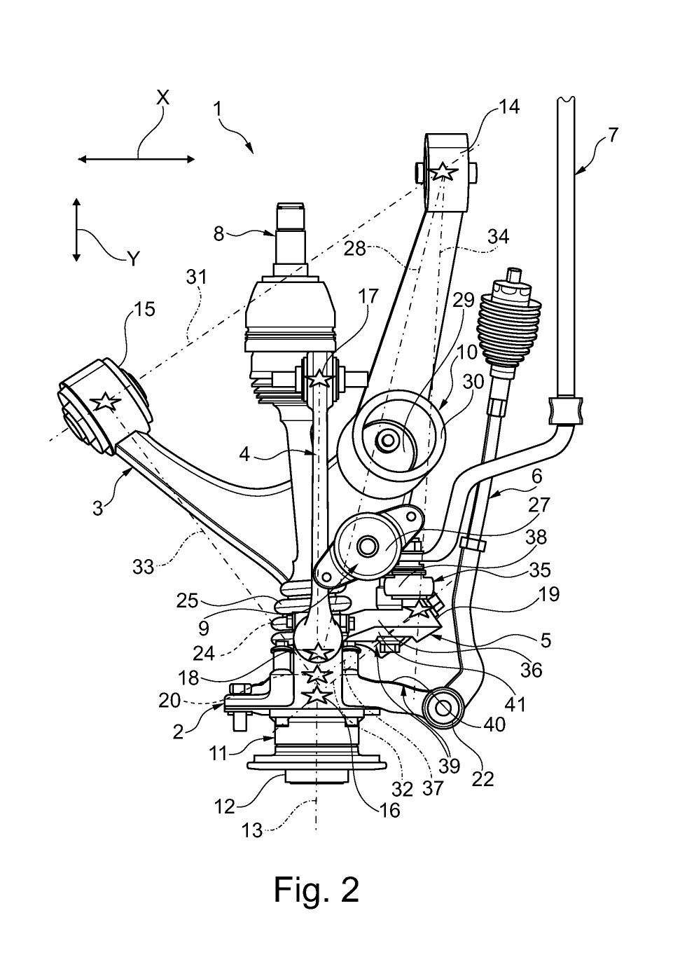

FIG. 2 a view in a vertical direction (Z axis) from above onto the wheel suspension,

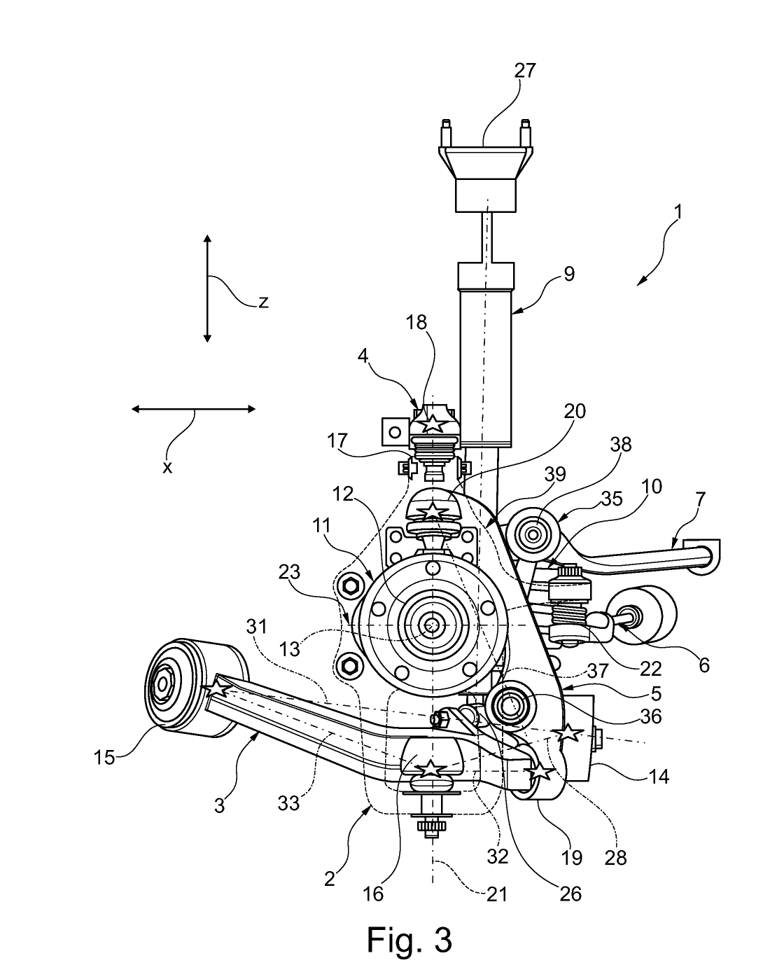

FIG. 3 a view from the outside in a transverse direction (Y axis) of the thus equipped vehicle.

### DETAILED DESCRIPTION

According to FIGS. 1 to 3, a wheel suspension 1, which serves, in the case of a motor vehicle (not illustrated), to support a wheel of the vehicle (not illustrated) on a structure of the vehicle (not illustrated), comprises a wheel carrier 2, a lower trapezoidal link 3, an upper camber link 4, a coupler link 5, a tie rod 6, a stabilizer 7, a drive shaft 8, a damper 9 and a spring 10. Here, the wheel suspension 1 is preferably conceived as an individual wheel suspension for a steerable and drivable rear wheel of a motor vehicle, preferably of a passenger motor vehicle.

For improved orientation, in FIGS. 1 to 3 for an installed state of the wheel suspension 1, in the vehicle, a vehicle longitudinal direction X, a vehicle transverse direction Y and a vehicle vertical axis Z are indicated by double arrows. The X axis and the Y axis span a horizontal X-Y plane. The X axis and the Z axis span a vertical X-Z plane. The Y axis and the Z axis span a further vertical Y-Z plane.

The wheel carrier 2 serves as a coupling to the wheel. For this purpose, a wheel bearing 11 is fixed on the wheel carrier 2, which mounts a wheel hub 12 rotatably around a wheel pivot 13. For improved understanding, the wheel carrier 2 in FIG. 3 is depicted transparently and with a dashed line.

The trapezoidal link 3 has, on the inside, a rear guide bearing 14 as well as a front guide bearing 15, via which the trapezoidal link 3 can be coupled respectively to the vehicle structure. On the outside, the trapezoidal link 3 is coupled to the wheel carrier 2 via a lower ball joint 16.

The camber link 4 is able to be connected to the structure on the inside with the help of an upper guide bearing 17. On the outside, the camber link 4 is coupled to the wheel carrier 2 via an upper ball joint 18.

The coupler link 5 is coupled to the trapezoidal link 3 via a lower coupler bearing 19 and to the wheel bearing 2 via an upper coupler bearing 20.

The lower ball joint 16, the upper coupler bearing 20 and the upper ball joint 18 define a steering axle 21 for steering movements between the wheel and the structure. The steered wheel can thus swivel around this steering axle 21 relative to the structure.

The tie rod 6 is coupled on the outside to the wheel carrier 2 via a footstep bearing 22. Therein the footstep bearing 22 is expediently arranged behind the wheel carrier 2, such that the tie rod 6 is introduced here from behind the wheel suspension 1. The tie rod 6 is coupled on the inside expediently to a steering device that is not shown here, with the help of which steering movements can be introduced into the wheel carrier 2. The upper coupler bearing 20 is now arranged between the upper ball joint 18 and the footstep bearing 22 on the wheel carrier 2. The footstep bearing 22 is arranged in a region of a horizontal wheel central plane 23, in which the wheel pivot 13 lies.

The drive shaft 8 is connected to be driven to the wheel hub 12 of the wheel bearing 11, whereby the vehicle wheel fixed on the wheel bearing 11 can be driven. While the drive shaft 8 is connected to be driven on the outside to the wheel hub 12, the drive shaft 8 can be connected on the inside to a drive train of the vehicle that is not shown here. Alternatively, an embodiment is also conceivable in which a separate electromotor is allocated to the respective wheel of the respective wheel suspension 1, the electromotor driving the wheel hub 12 via the drive shaft 8 and thus the related wheel. It is clear that the drive shaft 8 can then have a different appearance than in the figures shown here. The drive shaft 8 has a drive joint 24 which, in the views shown here, is enclosed by a cuff 25 and is thus covered. The drive joint 24 is, however, arranged in the region of the steering axle 21, so in particular lies on this steering axle 21.

The damper 9 is supported on the trapezoidal link 3 via a lower damper support 26. The damper 9 can be supported, for example, on the structure via an upper damper support 27. The lower damper support 26 is arranged in the region of a rear connection line 28. The rear connection line 28 connects the rear guide bearing 14 to the lower ball joint 16. The rear connection line 28 encloses an acute angle with the wheel pivot 13 of approximately 15°, which can also be moved in an angle range of 5° to 30°. In any case, the rear guide bearing 14 is thus situated behind the wheel pivot 13 and indeed preferably approximately in the region of a pneumatic trail which concentrates the transverse support of the wheel suspension 1 on the rear guide bearing 14 and thus unburdens the front guide bearing 15 accordingly.

The spring 10 is supported via a lower spring support 29 on the trapezoidal link 3 and can be supported for example on the vehicle structure via an upper support 30. The lower spring support 29 likewise lies in the region of the rear connection lines 28.

In the case of the embodiments shown here, the damper 9 and the spring 10 are conceived as separate components and are arranged eccentrically to each other. According to this, the lower damper support 26 and the lower spring support 29 are arranged next to each other and at a distance to each other on the trapezoidal link 3 in the region of the rear connection lines 28. Therein the spring 10 is arranged further inside than the damper 9. In particular, the spring 10 is supported on the trapezoidal link 3 approximately centrally between rear guide bearing 14 and lower ball joint 16.

The top view according to FIG. 2 represents a projection having a vertical project direction (Z axis) and a horizontal projection plane (X-Y plane). In this projection or in this projection plane, an inner connection line 31 and an outer connection line 32 run substantially parallel to each other. In particular, their orientations deviate from each other by less than 5°. The inner connection line 31 connects the rear guide bearing 14 to the front guide bearing 15. The outer connection line 32 connects the lower coupler bearing 19 to the lower ball joint 16. In this projection of FIG. 2, a front connection line 33 stands substantially perpendicularly on the inner connection lines 31 and thus likewise substantially perpendicularly on the outer connection lines 32. Here, deviations from the right angle are also expediently smaller than 5°. The front connection line 33 connects the front guide bearing 15 to the lower ball joint 16. In FIG. 2, furthermore a further connection line 34 is depicted that connects the front guide bearing 14 to the lower coupler bearing 19. In the projection of FIG. 2, this further connection line 34, the inner connection line 31, the front connection line 33 and the outer connection line 32 define a trapeze, which gives it name to the trapezoidal link 3. In the shown particular case, this trapeze has two mostly right angles.

The side view according to FIG. 3 represents a projection having a horizontal projection direction (Y axis) and a vertical projection plane (X-Z plane). In this projection or in this projection plane, the wheel pivot 13 lies on the steering axle 21. Furthermore, a wheel contact point not shown here, via which the respective wheel contacts a subsurface or a road, likewise lies on the steering axle 21. Furthermore, the steering axle 21 extends in this projection mostly in parallel to the Z axis. In other words, the steering axle 21 lies in the Y-Z plane.

According to FIG. 1, the steering axle 21 can have an incline, which can lie in a range, for example, from 5° to 30°, compared to the vertical direction (Z axis).

The stabilizer 7 is coupled to the coupler link 5 inside of the wheel suspension 1 via a pendulum strut 35. Therein the pendulum strut 35 is coupled to the coupler link 5 via a lower pendulum bearing 36. The lower pendulum bearing 36 is therein arranged on the coupler link 5 between the lower coupler bearing 19 and the upper coupler bearing 20. Furthermore, the lower pendulum bearing 36 lies on a connection line 37 which connects the lower coupler bearing 19 to the upper coupler bearing 20. The pendulum strut 35 is furthermore coupled to the stabilizer 7 via an upper pendulum bearing 38. This upper pendulum bearing 38 is arranged approximately in the height region of the upper coupler bearing 20 with regard to the Z axis.

The vehicle suspension 1 is furthermore equipped with a steering stop 39 having a first stop contour 40 and a second stop contour 41. The two stop contours 40, 41 come to rest on each other on achieving a predetermined, maximum steering angle between the wheel and the structure. The first stop contour 40 is formed here on the wheel carrier 2 and indeed expediently in the region of the upper coupler bearing 20. The second stop contour 41 is formed on the coupler link 5 and indeed likewise in the region of the upper coupler bearing 20. In the embodiment shown here, the two stop contours 40, 41 are formed integrally on the wheel carrier 2 or integrally on the coupler link 5. Alternatively, an embodiment is also conceivably in which the first stop contour 40 is formed by a separate stop body which is attached to the wheel carrier 2. Additionally or alternatively, the second stop contour 41 can be formed by a separate stop body, which is attached to the coupler link 5. Expediently, the stop contours 40, 41 are designed for surface contact, whereby force peaks can be reduced on achieving the maximum steering angle.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-12. (canceled)

13. A wheel suspension for a motor vehicle to support a wheel of the vehicle on a structure of the vehicle, the wheel suspension comprising:
a wheel carrier configured for coupling to the wheel;
a lower trapezoidal link, which has, on an inside, a rear guide bearing configured for coupling to the structure of the vehicle and a front guide bearing configured for coupling to the structure of the vehicle and which is coupled, on an outside, to the wheel carrier via a lower ball joint;
an upper camber link which has, on an inside, an upper guide bearing configured for coupling to the structure of the vehicle and which is coupled, on an outside, to the wheel carrier via an upper ball joint;
a coupler link coupled to the lower trapezoidal link via a lower coupler bearing and to the wheel carrier via an upper coupler link,
wherein an inner connection line connecting the rear guide bearing to the front guide bearing runs, in a projection having a vertical projection direction and a horizontal projection plane, substantially in parallel to an outer connection line connecting the lower coupler bearing to the lower ball joint.

14. The wheel suspension of claim 13, wherein the rear guide bearing and the front guide bearing are arranged spatially such that the inner connection line extends frontwards, upwards, and outwards, originating from the rear guide bearing.

15. The wheel suspension of claim 13, wherein
a front connection line connecting the front guide bearing to the lower ball joint, runs, in this projection, substantially perpendicularly to the inner connection line, or
the lower ball joint, the upper coupler bearing, and the upper ball joint define a steering axle for steering movements between wheel and structure of the vehicle.

16. The wheel suspension of claim 13, further comprising:
a tie rod coupled, on an outside, to the wheel carrier via a footstep bearing,
wherein the upper coupler bearing is arranged on the wheel carrier between the upper ball joint and the footstep bearing.

17. The wheel suspension of claim 16, wherein the footstep bearing lies in a region of a horizontal wheel central plane in which a wheel pivot lies.

18. The wheel suspension of claim 15, further comprising:
a wheel bearing fixed to a wheel carrier; and
a drive shaft configured to drive a wheel hub of the wheel bearing, the drive shaft having a drive joint lying in a region of the steering axle.

19. The wheel suspension of claim 13, further comprising:
a damper supported on a trapezoidal link via a lower damper support, wherein the lower damper support lies in a region of a rear connection line connecting the rear guide bearing to the lower ball joint.

20. The wheel suspension of claim 13, further comprising:
a spring supported on a trapezoidal link via a lower spring support, wherein the lower spring support lies in a region of a rear connection line connecting the rear guide bearing to the lower ball joint.

21. The wheel suspension of claim 13, further comprising:
a damper supported on a trapezoidal link via a lower damper support, wherein the lower damper support lies in a region of a rear connection line connecting the rear guide bearing to the lower ball joint;
a spring supported on the trapezoidal link via a lower spring support, wherein the lower spring support lies in the region of the rear connection line connecting the rear guide bearing to the lower ball joint,
wherein the damper and the spring are arranged separately and eccentrically to each other.

22. The wheel suspension of claim 13, further comprising:
a stabiliser coupled to the coupler link via a pendulum strut.

23. The wheel suspension of claim 13, further comprising:
a steering stop having a first stop contour and a second stop contour, which abut onto each other at a predetermined maximum steering angle between wheel and structure,
wherein the first stop contour is formed on the wheel carrier, and the second stop contour is formed on the coupler link.

24. A vehicle, comprising:
a structure;
several wheels; and
at least one wheel suspension supporting one of the wheels on the structure, the at least one wheel suspension comprising
a wheel carrier configured for coupling to the wheel;
a lower trapezoidal link, which has, on an inside, a rear guide bearing configured for coupling to the structure of the vehicle and a front guide bearing configured for coupling to the structure of the vehicle and which is coupled, on an outside, to the wheel carrier via a lower ball joint;
an upper camber link which has, on an inside, an upper guide bearing configured for coupling to the structure of the vehicle and which is coupled, on an outside, to the wheel carrier via an upper ball joint;
a coupler link coupled to the lower trapezoidal link via a lower coupler bearing and to the wheel carrier via an upper coupler link,
wherein an inner connection line connecting the rear guide bearing to the front guide bearing runs, in a projection having a vertical projection direction and a horizontal projection plane, substantially in parallel to an outer connection line connecting the lower coupler bearing to the lower ball joint.
